(19) United States
(12) Patent Application Publication
(10) Pub. No.: US 2020/0327480 A1
(43) Pub. Date: Oct. 15, 2020

(54) ORGANIZATION CAPABILITY EVALUATION SYSTEM

(71) Applicant: JTEKT CORPORATION, Osaka-shi (JP)

(72) Inventors: Kazuma SUZUKI, Kariya-shi (JP); Masahiro HAYASHI, Kariya-shi (JP)

(73) Assignee: JTEKT CORPORATION, Osaka-shi (JP)

(21) Appl. No.: 16/835,646

(22) Filed: Mar. 31, 2020

(30) Foreign Application Priority Data
Apr. 9, 2019 (JP) 2019-074122

(51) Int. Cl. G06Q 10/06; G06Q 50/04

(52) U.S. Cl. CPC G06Q 10/063114; G06Q 50/04; G06Q 10/063112; G06Q 10/063118

(57) ABSTRACT

An organization capability evaluation system configured to evaluate an organization capability when an organization including a plurality of workers manufactures various products through a plurality of steps, includes a work performance acquisition unit configured to acquire a working time required for work in each of the plurality of steps, an evaluation reference storage unit configured to store a reference working time set for each of the steps, a working capability calculation unit configured to calculate a working capability of each step based on the step-specific work performance and the reference working time, a working capability storage unit configured to store the working capability of each step calculated by the working capability calculation unit, and a step-specific organization capability calculation unit configured to calculate the organization capability for each step based on the step-specific working capability.

### CROSS REFERENCE TO RELATED APPLICATIONS

This application claims priority from Japanese Patent Application No. 2019-074122 filed on Apr. 9, 2019, the entire contents of which are incorporated herein by reference.

### BACKGROUND OF THE INVENTION

### Field of the Invention

The present invention relates to an organization capability evaluation system.

### Background of the Invention

### FIELD OF THE INVENTION

Patent Literature 1 discloses a technology in which workers are allocated to a manufacturing line by using a capability master table updated based on a work performance of a worker, and the allocation of workers are adjusted according to a progress of the work. Patent Literature 2 discloses a technology in which a working capability of each worker included in a group is estimated based on an actual working time and a working capability of the group is calculated based on the estimated working capability of each worker.
[Patent Literature 1] JP-A-2002-6934
[Patent Literature 2] JP-A-10-254962

Work to be performed in each step of the manufacturing line is diverse. Accordingly, the worker is not always required to have the same working capability for all the work performed in respective steps of the manufacturing line. That is, even if the same workers are allocated to the manufacturing line, the working capability of the manufacturing line may vary if each worker works at a different step in the manufacturing line. Further, even if each worker works at the same step in the manufacturing line, work content to be performed in each step of the manufacturing line is also changed if the product to be manufactured in the manufacturing line is different, so that the working capability of the manufacturing line may vary. Further, in an organization for manufacturing a product on a plurality of manufacturing lines, if working capability of each manufacturing line varies, the productivity of the organization also varies.

From this point, a manager of the organization is required to arrange the workers such that the productivity of the organization is maintained, for example, even when one of the workers who belongs to the organization is absent for some reason. In other words, it is desirable for the manager to appropriately evaluate the working capability of each worker so as to stabilize the productivity of the organization at a high level even if there is a situation change such as a vacancy occurs in the workers. However, it is not easy for the organization manager to appropriately evaluate the working capabilities of all workers belonging to the organization and stabilize the productivity of the organization at a high level.

### SUMMARY

One or more embodiments provide an organization capability evaluation system capable of appropriately evaluating the working capability of a worker and an organization capability evaluation system capable of stabilizing productivity of an organization at a high level.

In an aspect (1), an organization capability evaluation system configured to evaluate an organization capability when an organization including a plurality of workers manufactures various products through a plurality of steps, includes a work performance acquisition unit configured to acquire a working time required for work in each of the plurality of steps as a step-specific work performance, an evaluation reference storage unit configured to store a reference working time set for each of the steps as an evaluation reference when evaluating the step-specific work performance, a working capability calculation unit configured to calculate a working capability of each step based on the step-specific work performance and the reference working time, a working capability storage unit configured to store the working capability of each step calculated by the working capability calculation unit as a step-specific working capability, and a step-specific organization capability calculation unit configured to calculate the organization capability for each step based on the step-specific working capability. The organization capability calculation unit is a step-specific organization capability calculation unit configured to calculate the organization capability for each step based on the step-specific working capability.

According to the aspect (1), an organization manager can appropriately evaluate the step-specific working capability of each worker based on the calculation result of the step-specific organization capability calculation unit. Then, the manager can accurately grasp the step-specific organization capability by using the first organization capability evaluation system. Therefore, when it is evaluated that an organization capability of a specific step is low, the manager can take measures to increase the organization capability of the step. Further, the manager can increase the productivity of the organization by increasing step-specific organization capabilities of all the steps.

In an aspect (2), an organization capability evaluation system configured to evaluate an organization capability when an organization including a plurality of workers manufactures various products through a plurality of steps, includes a work performance acquisition unit configured to acquire a working time required for work in each of the plurality of steps as a step-specific work performance, an evaluation reference storage unit configured to store a reference working time set for each of the steps as an evaluation reference when evaluating the step-specific work performance, a working capability calculation unit configured to calculate a working capability of each step based on the step-specific work performance and the reference working time, a working capability storage unit configured to store the working capability of each step calculated by the working capability calculation unit as a step-specific working capability, and a step-specific organization capability calculation unit configured to calculate the organization capability for each step based on the step-specific working capability. The organization capability calculation unit is a product-specific organization capability calculation unit configured to calculate the organization capability for each product based on the step-specific working capability.

According to the aspect (2), the organization manager can appropriately evaluate the product-specific working capability of each worker based on the calculation result of the product-specific organization capability calculation unit. Then, the manager can accurately grasp the product-specific organization capability by using the second organization capability evaluation system. Accordingly, when it is evaluated that an organization capability during manufacturing a specific product is low, the manager can take measures to increase the organization capability during manufacturing the product. Further, the manager can increase the productivity of the organization by increasing product-specific organization capabilities of all the products to be manufactured.

In an aspect (3), an organization capability evaluation system configured to evaluate an organization capability when an organization including a plurality of workers manufactures various products through a plurality of steps, includes a work performance acquisition unit configured to acquire a working time required for work in each of the plurality of steps as a step-specific work performance, an evaluation reference storage unit configured to store a reference working time set for each of the steps as an evaluation reference when evaluating the step-specific work performance, a working capability calculation unit configured to calculate a working capability of each step based on the step-specific work performance and the reference working time, a working capability storage unit configured to store the working capability of each step calculated by the working capability calculation unit as a step-specific working capability, and a step-specific organization capability calculation unit configured to calculate the organization capability for each step based on the step-specific working capability. The organization capability calculation unit is a line-specific organization capability calculation unit configured to calculate the organization capability for each production line based on the step-specific working capability.

According to the aspect (3), the organization manager can appropriately evaluate the production line-specific organization capability based on the calculation result of the line-specific organization capability calculation unit. Then, the manager can accurately grasp the organization capability of each production line by using the third organization capability evaluation system. Therefore, when it is evaluated that an organization capability in a specific production line is lower than organization capabilities in the other production lines, the manager can take measures to increase the organization capability of the specific production line. Then, the manager can increase the productivity of the organization by increasing the production line-specific organization capabilities of all the production lines.

In an aspect (4), an organization capability evaluation system configured to evaluate an organization capability when an organization including a plurality of workers manufactures various products through a plurality of steps, includes a work performance acquisition unit configured to acquire a working time required for work in each of the plurality of steps as a step-specific work performance, an evaluation reference storage unit configured to store a reference working time set for each of the steps as an evaluation reference when evaluating the work performance, a working capability calculation unit configured to calculate a working capability of each step based on the step-specific work performance and the reference working time, an achievement degree calculation unit configured to calculate an achievement degree of the working times with respect to the reference working time for each of the steps based on the plurality of step-specific work performances and the reference working time, a stability degree calculation unit configured to calculate a stability degree of the working times with respect to the reference working time for each of the steps based on the plurality of step-specific work performances and the reference working time, and an organization capability calculation unit configured to calculate the organization capability based on the achievement degree and the stability degree. The stability degree is a variance of working times.

According to the aspect (4), since the organization capability calculation unit calculates the organization capability based on the achievement degree and stability degree of the working times with respect to the reference working time, the organization manager can evaluate the organization capability appropriately. Therefore, when it is evaluated that the organization capability is low, the manager can take measures to increase the organization capability. Then, the manager can stabilize the productivity of the organization at a high level by increasing the organization capability.

### BRIEF DESCRIPTION OF THE DRAWINGS

FIG. 1 is a schematic diagram of a production facility provided with a plurality of production lines.

FIG. 2A illustrates a part of a functional block diagram of an organization capability evaluation system. FIG. 2B illustrates a part of the functional block diagram of the organization capability evaluation system.

FIG. 3 is a table showing an example of work performances recorded in a work performance recording unit.

FIG. 4 is a table showing an example of five working times.

FIG. 5 is a table generated based on the table shown in FIG. 4, and showing working times converted for achievement degree calculation and a sum and average of five working times.

FIG. 6 is a table generated based on the table shown in FIG. 4, and showing working times converted for stability degree calculation and a sum and variance of five working times.

FIG. 7 is a table showing, for each product, step-specific working capabilities in a first production line.

FIG. 8 is a table showing an example of a calculation result of a step-specific organization capability calculation unit.

FIG. 9 is a table showing an example of a calculation result of a product-specific organization capability calculation unit.

FIG. 10 is a table showing an example of a calculation result of a first line-specific organization capability of a line-specific organization capability calculation unit.

FIG. 11 is a table showing an example of a calculation result of a second line-specific organization capability of the line-specific organization capability calculation unit.

FIG. 12 is a table showing an example of individual capabilities stored in an individual capability storage unit.

FIG. 13 shows an example of a graph showing transition of step-specific organization capabilities displayed on a display unit.

### DETAILED DESCRIPTION

### (1. Summary of Production Facility 1)

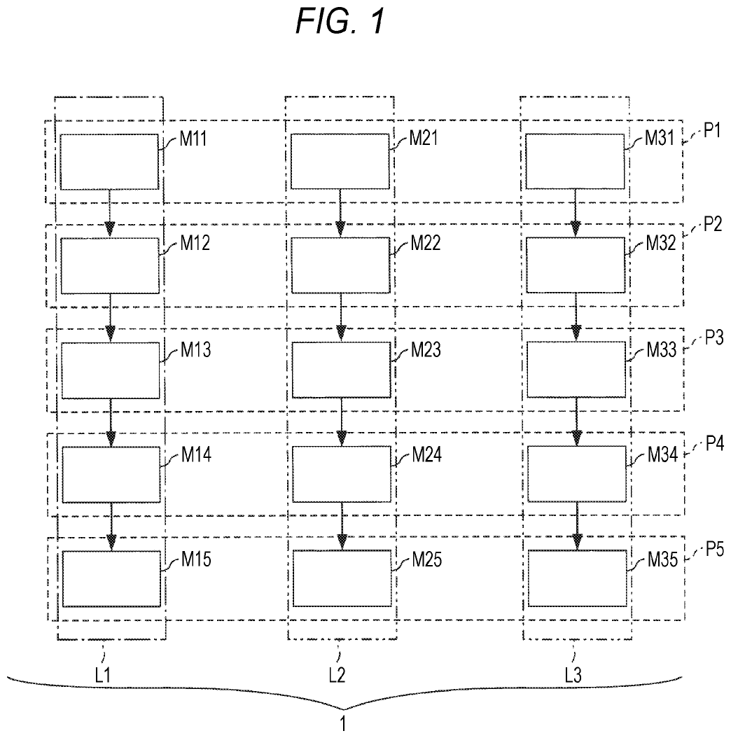

First, a production facility 1 to which an organization capability evaluation system 50 is to be applied will be described with reference to FIG. 1. The production facility 1 is a facility used by an organization including a plurality of workers to produce various products.

As shown in FIG. 1, a plurality of production lines L1 to L3 are provided in the production facility 1 and a plurality of machine tools M are arranged in each of the production lines L1 to L3. An organization manager assigns a plurality of workers to each of the production lines L1 to L3, and the workers operate the respective machine tools M arranged in each of the production lines L1 to L3.

The organization manufactures various products in the respective production lines L1 to L3. For example, the organization manufactures automobiles, automobile parts, industrial machines and the like in the respective production lines L1 to L3. The organization may manufacture different products at the same time in the respective production lines L1 to L3, and may also manufacture the same product at the same time in all the production lines L1 to L3. Further, the organization may continuously manufacture the same product in each of the production lines L1 to L3, and may also change the product to be manufactured according to a situation.

In the present embodiment, manufacturing steps of the product in each of the production lines L1 to L3 includes a first step P1, a second step P2, a third step P3, a fourth step P4, and a fifth step P5. The first step P1 is a step in which the worker performs an operation using first machine tools M11, M21, and M31. In the present embodiment, all of the first machine tools M11, M21, and M31 are the same type of machine tools, and the worker can operate the first machine tools M21 and M31 by an operation method similar to an operation method of the first machine tool M11.

The second step P2 is a step in which the worker performs an operation using second machine tools M12, M22, and M32, and an operation is performed on an intermediate product manufactured in the first step P1. In the present embodiment, all of the second machine tools M12, M22, and M32 are the same type of machine tools. The third step P3 is a step in which the worker performs an operation using third machine tools M13, M23, and M33, and an operation is performed on an intermediate product manufactured in the second step P2. In the present embodiment, all of the third machine tools M13, M23, and M33 are the same type of machine tools.

The fourth step P4 is a step in which the worker performs an operation using fourth machine tools M14, M24, and M34, and an operation is performed on an intermediate product manufactured in the third step P3. In the present embodiment, all of the fourth machine tools M14, M24, and M34 are the same type of machine tools. The fifth step P5 is a step in which the worker performs an operation using fifth machine tools M15, M25, and M35, and an operation is performed on an intermediate product manufactured in the fourth step P4. In the present embodiment, all of the fifth machine tools M15, M25, and M35 are the same type of machine tools. Further, on a product completed in the fifth step P5, quality inspection is performed in a quality inspection step to be performed thereafter.

The number of steps included in each of the production lines L1 to L3 can be set freely. Further, in a product to be manufactured in each production line L1 to L3, if there is an unnecessary step, the step can be omitted. Further, the quality inspection step may be performed not only after a final step but also between steps.

### (2. Organization Capability Evaluation System 50)

The organization capability evaluation system 50 evaluates, as an organization capability, a production capability when an organization including a plurality of workers manufactures various products through a plurality of steps. Mainly, the organization capability evaluation system 50 acquires a time length (a working time) required for the work in each step included in structural steps of the product, and evaluates the organization capability based on the acquired working time.

For example, the organization capability evaluation system 50 can calculate, based on a working time required in a specific step, a step-specific organization capability of the step. The organization capability evaluation system 50 can calculate, based on a working time required in each step when manufacturing a specific product, a product-specific organization capability of the product. Further, the organization capability evaluation system 50 can calculate an organization capability for each of the production lines L1 to L3 by calculating the step-specific organization capabilities or the product-specific organization capabilities for each of the production lines L1 to L3. Then, the organization manager can use an evaluation result of the organization capability evaluation system 50, for example, to improve the productivity of the organization.

### (3. Configuration of Organization Capability Evaluation System 50)

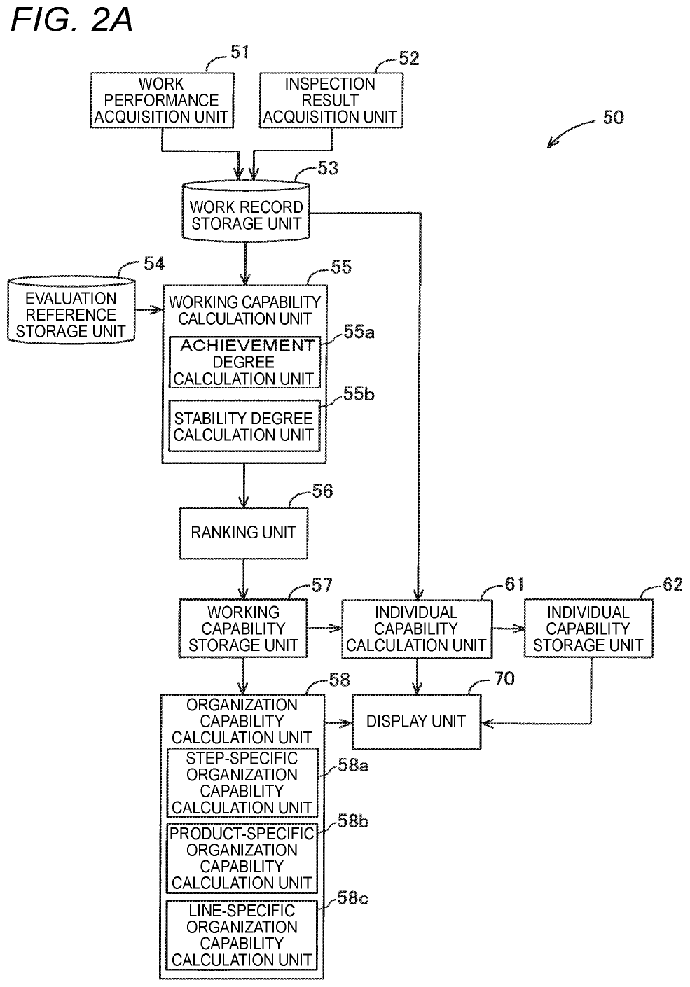

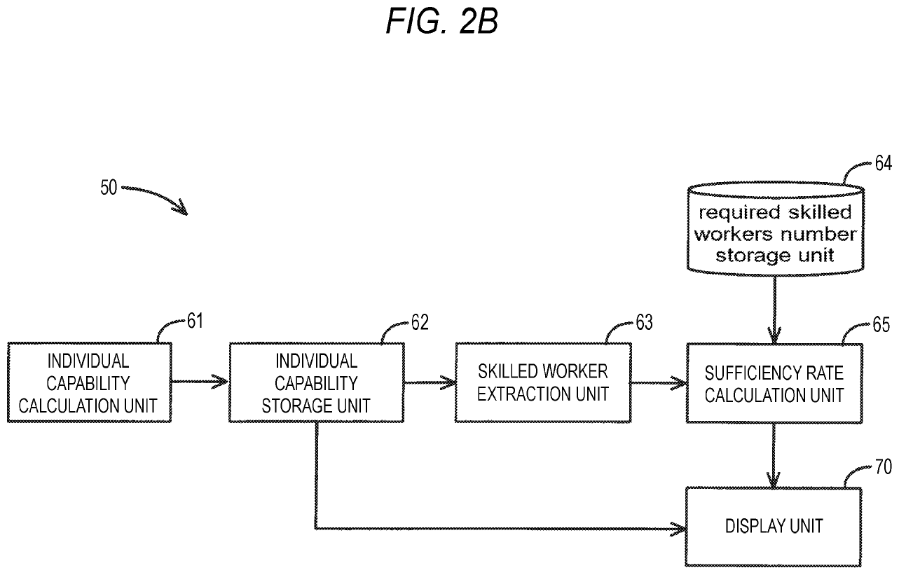

Next, a configuration of the organization capability evaluation system 50 will be described. As shown in FIG. 2A, the organization capability evaluation system 50 mainly includes a work performance acquisition unit 51, an inspection result acquisition unit 52, a work record storage unit 53, an evaluation reference storage unit 54, a working capability calculation unit 55, a ranking unit 56, a working capability storage unit 57, an organization capability calculation unit 58, and a display unit 70.

As shown in FIG. 2B, the organization capability evaluation system 50 further includes an individual capability calculation unit 61, an individual capability storage unit 62, a skilled worker extraction unit 63, a required skilled workers number storage unit 64, and a sufficiency rate calculation unit 65.

When the organization manufactures a product using the production facility 1, the work performance acquisition unit 51 acquires a working time required for the work in each of the steps P1 to P5 as a step-specific work performance. For example, in the production facility 1, a start button for indicating a start of the work and an end button for indicating an end of the work are installed in a work area of each of workers who work using the machine tools M11 to M15, M21 to M25, and M31 to M35. Each worker presses a start button when starting the work in a step in charge, and presses an end button when the work ends. Further, the work performance acquisition unit 51 acquires a time length from a time point when the start button is pressed to a time point when the end button is pressed as a working time per one time in each step. The production facility 1 may employ a system that automatically detects the start and end of the work instead of using the start button and the end button.

The inspection result acquisition unit 52 acquires information relating to an inspection result of quality inspection performed on a product manufactured in each of the production lines L1 to L3. For example, the inspection result acquisition unit 52 acquires inspection result information input by a worker who performed the quality inspection. The quality inspection includes a plurality of inspection items, and an inspection result is shown for each item. For example, a measurement value obtained when a measurement relating to the product is performed in the quality inspection is compared with a preset threshold value, if the inspection result is good, “O” is set, and if the inspection result is bad, “X” is set.

The inspection items included in the quality inspection are associated with the manufacturing steps. That is, when an inspection item is defective, the organization manager can estimate that some sort of trouble has occurred in a manufacturing step associated with the inspection item determined to be defective. For example, in a case where the first step P1 is associated with inspection items 1 and 2, if the inspection item 1 or 2 is defective, the organization manager can estimate that some sort of trouble has occurred in the first step P1.

The work record storage unit 53 stores the working time information relating to the working time acquired by the work performance acquisition unit 51 and the inspection result information acquired by the inspection result acquisition unit 52. In addition, the work record storage unit 53 acquires various work records obtained when the organization manufactures a product using the production facility 1.

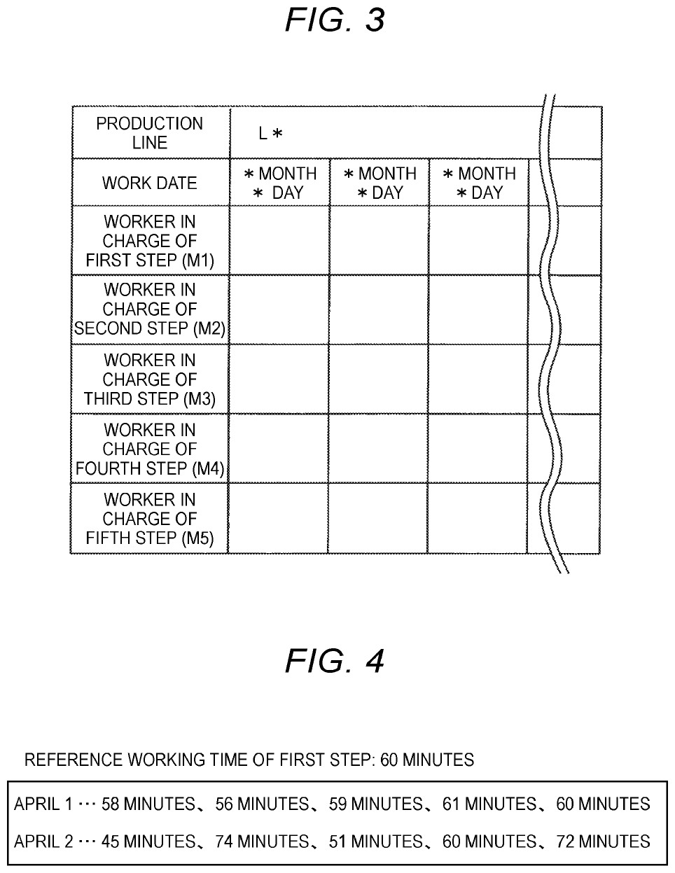

As shown in FIG. 3, the work record storage unit 53 stores, for example, a work record for each of the production lines L1 to L3. Further, in the work record storage unit 53, a work date and a name of a worker in charge (worker who operates each machine tool M11 to M15, M21 to M25, and M31 to M35) of each of the steps P1 to P5 included in each of the production lines L1 to L3 are recorded. Instead of storing the work record for each of the production lines L1 to L3, the work record storage unit 53 may store the work record for each worker, each model of the machine tool M, or each product. Further, when an arrangement of the workers is changed on the same work date, the working time can be stored in the work record storage unit 53.

The evaluation reference storage unit 54 stores a reference working time serving as a reference of the working time in each of the steps P1 to P5 as an evaluation reference when evaluating the work performance. For example, the reference working time is set based on a production plan determined by the organization manager or the like. The manager or the like can set, for each product, a reference working time in each of the steps P1 to P5.

The working capability calculation unit 55 calculates a working capability for each step (hereinafter, referred to as “step-specific working capability”) by executing preset calculation processing on a computer based on the step-specific work performance stored in the work record storage unit 53 and the reference working time stored in the evaluation reference storage unit. The step-specific working capability is an index indicating how much the actual working time acquired as the work performance is with respect to the reference working time, and is a value indicating the evaluation result of the work performance.

Specifically, the working capability calculation unit 55 includes an achievement degree calculation unit 55a and a stability degree calculation unit 55b. The achievement degree calculation unit 55a calculates an achievement degree of the working time with respect to the reference working time based on a plurality of work performances acquired within a predetermined period and the reference working time. The stability degree calculation unit 55b calculates a stability degree of the working time with respect to the reference working time based on the plurality of work performances acquired within a predetermined period and the reference working time. That is, the working capability calculation unit 55 calculates, as a step-specific work performance within the predetermined period, the achievement degree indicating a degree of satisfaction of a working time required for the step to the reference working time and the stability degree indicating a degree of variation of the working times required for the step. In this way, the working capability calculation unit 55 calculates two indexes, the achievement degree and stability degree, as the working capability. Hereinafter, the achievement degree and stability degree of the working time will be described with reference to specific examples.

FIG. 4 illustrates working times of the first step P1 when manufacturing a product X in the first production line L1. Here, a reference working time of the first step P1 during manufacturing the product X is set to 60 minutes.

When calculating the achievement degree, in a case where the working time recorded in the work record storage unit 53 satisfies the reference working time, that is, if the actual working time is within the reference working time, the achievement degree calculation unit 55a replaces the actual working time with the reference working time, and sets the reference working time as a working time for achievement degree calculation. Meanwhile, in a case where the working time recorded in the work record storage unit 53 does not satisfy the reference working time, that is, in a case where the actual working time exceeds the reference working time, the achievement degree calculation unit 55a sets the actual working time as the working time for the achievement degree calculation. Then, the achievement degree calculation unit 55a calculates the achievement degree using a plurality of working times for the achievement degree calculation.

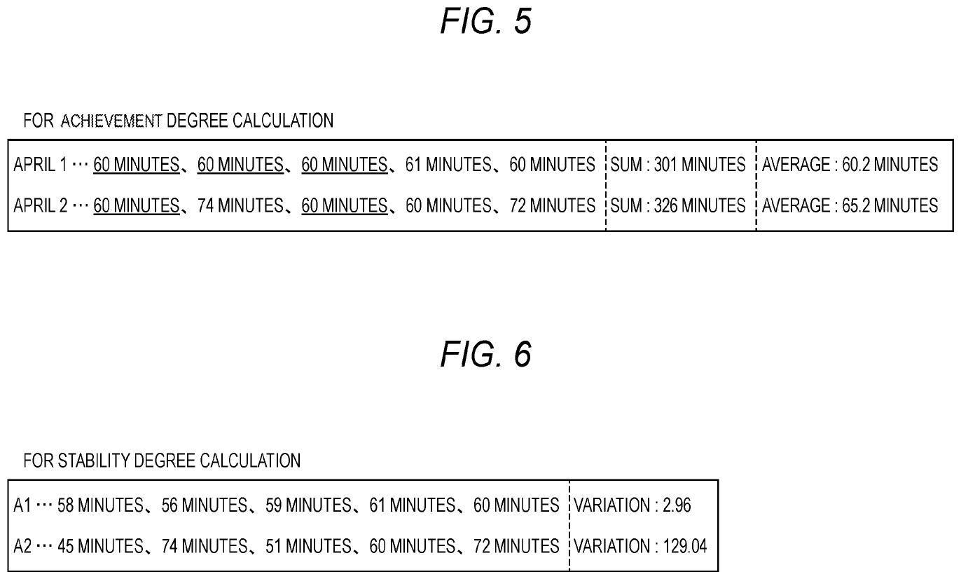

For example, as shown in FIG. 5, five working times of the first step P1 in which the work date is April 1 in the example shown in FIG. 4 are 58 minutes, 56 minutes, 59 minutes, 61 minutes, and 60 minutes. In this case, the working times for calculating the achievement degree are converted into 60 minutes, 60 minutes, 60 minutes, 61 minutes, and 60 minutes. Further, five working times of the first step P1 in which the work dates is April 2 in the example shown in FIG. 4 are 45 minutes, 74 minutes, 51 minutes, 60 minutes, and 72 minutes. In this case, the working times for calculating the achievement degree are converted into 60 minutes, 74 minutes, 60 minutes, 60 minutes, and 72 minutes. The reason is to evaluate whether or not the working time for each step satisfies the reference working time, and to evaluate a degree of a dissatisfaction state when the working time does not satisfy the reference working time.

Subsequently, the achievement degree calculation unit 55a calculates an average of the plurality of working times converted for the achievement degree calculation as one index of the achievement degree. In the example shown in FIG. 5, an average serving as the achievement degree of the first step P1 in which the work date is April 1 is 60.2 minutes, and an average serving as the achievement degree of the first step P1 in which the work date is April 2 is 65.2 minutes. With respect to the achievement degree, if the average serving as the achievement degree is 60 minutes, it means that all the actual working times satisfy the reference time length, and if the average is more than 60 minutes, it means that the actual working time does not satisfy the reference time length.

On the other hand, when calculating the stability degree, the stability degree calculation unit 55b sets the working time acquired by the work performance acquisition unit 51 as a working time for stability degree calculation, and calculates the stability degree of a plurality of working times using the working times for the stability degree calculation.

For example, as shown in FIG. 6, five working times for stability degree calculation of the first step P1 in which the work date is April 1 in the example shown in FIG. 4 are 58 minutes, 56 minutes, 59 minutes, 61 minutes, and 60 minutes. Similarly, five working times for the stability degree calculation of the first step P1 in which the work date is April 2 in the example shown in FIG. 4 are 45 minutes, 74 minutes, 51 minutes, 60 minutes, and 72 minutes.

Subsequently, the stability degree calculation unit 55b calculates a variance of a plurality of working times for the stability degree calculation as one index serving as the stability degree. For example, a variance serving as the stability degree of the first step P1 in which the work date is April 1 is 2.96, and a variance serving as the stability degree of the first step P1 in which the work date is April 2 is 129.04. With respect to the stability degree, the closer the variance of the stability degree is to 0, the smaller the variation of the working times is and the higher the stability degree of the working times is.

The ranking unit 56 performs step-specific working capability ranking according to the step-specific working capabilities calculated by the working capability calculation unit 55. As described above, the working capability calculation unit 55 calculates the achievement degree and stability degree of the working time as the step-specific working capability. Accordingly, the ranking unit 56 evaluates the achievement degree and the stability degree in a stepwise manner and performs ranking.

Specifically, the ranking unit 56 determines a level of the achievement degree (hereinafter, referred to as “achievement degree level”) using the average serving as the achievement degree. The achievement degree level is divided into a plurality of levels (for example, five levels). In the present embodiment, when the average serving as the achievement degree is a small value, the ranking unit 56 determines that the achievement degree level is high, and assigns a high rank (for example, level 5). On the other hand, when the average serving as the achievement degree is a large value, the ranking unit 56 determines that the achievement degree level is low, and assigns a low rank (for example, level 1).

Although the case where the average is used as one index of the achievement degree has been described here as an example, statistics other than the average can be used. For example, the achievement degree may use statistics that can only represent the presence or absence of satisfaction.

Further, the ranking unit 56 determines a level of the stability degree (hereinafter, referred to as “stability degree level”) using the variance serving as the stability degree. The stability degree level is divided into a plurality of levels (for example, five levels). In the present embodiment, when the variance serving as the stability degree is a small value, the ranking unit 56 determines that the stability degree level is high, and assigns a high rank (for example, level 5). On the other hand, when the variance serving as the stability degree is a large value, the ranking unit 56 determines that the stability degree level is low, and assigns a low rank (for example, level 1). Although the case where the variance is used as one index of the stability degree has been described here as an example, statistics other than the variance can be used.

Subsequently, the ranking unit 56 determines a level of the step-specific working capability based on the achievement degree level and the stability degree level. For example, the ranking unit 56 ranks an average or sum of the achievement degree level and the stability degree level as a rank of the step-specific working capability. Then, ranks of the step-specific working capabilities ranked by the ranking unit 56 are stored in the working capability storage unit 57.

Here, the working capability calculation unit 55 can calculate an achievement degree of inspection results of a plurality of products acquired by the inspection result acquisition unit 52. In this case, the ranking unit 56 can also rank the achievement degree of the inspection results, and determine the level of the step-specific working capability based on the achievement degree of the inspection results, and the achievement degree and stability degree of the working time. In this case, the working capability calculation unit 55 can set not only the working time but also a quality of a manufactured product as evaluation targets of the working capability.

The organization capability calculation unit 58 calculates an organization capability serving as an index indicating the productivity of the organization, based on the ranks of the step-specific working capabilities stored in the working capability storage unit 57. The organization capability calculation unit 58 includes a step-specific organization capability calculation unit 58a for calculating an organization capability for each step, a product-specific organization capability calculation unit 58b for calculating an organization capability for each product, and a line-specific organization capability calculation unit 58c for calculating an organization capability for each production line.

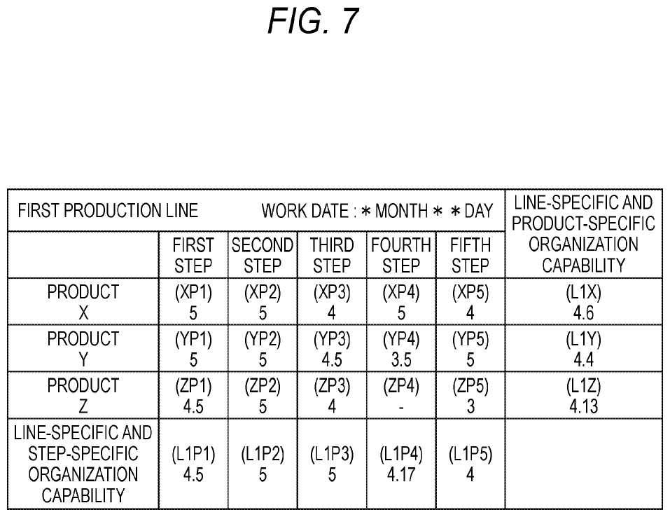

FIG. 7 shows a table showing step-specific and product-specific working capabilities calculated based on the work performances obtained during manufacturing various products in the production line L1 throughout one day. In the example shown in FIG. 7, products produced in the production line L1 are three types of products, X, Y, and Z. The products X and Y are manufactured through five steps from the first step P1 to the fifth step P5, whereas the product Z is manufactured through four steps other than the fourth step P4. That is, the manufacturing steps of the product Z do not include the fourth step P4.

In the example shown in FIG. 7, the step-specific organization capability calculation unit 58a calculates an average of a rank XP1 of the first step P1 during manufacturing the product X, a rank YP1 of the first step P1 during manufacturing the product Y, and a rank ZP1 of the first step P1 during manufacturing the product Z, as a step-specific working capability L1P1 of the first step P1 in the first production line L1. Similarly, the step-specific organization capability calculation unit 58a calculates an average of a rank XP2 of the second step P2 during manufacturing the product X, a rank YP2 of the second step P2 during manufacturing the product Y, and a rank ZP2 of the second step P2 during manufacturing the product Z, as a step-specific working capability L1P2 of the second step P2 in the first production line L1. In the similar manner, the step-specific organization capability calculation unit 58a calculates step-specific working capabilities L1P3, L1P4, and L1P5 of the third step P3, the fourth step P4, and the fifth step P5 in the first production line L1.

Further, similarly to the case of the first production line L1, the step-specific organization capability calculation unit 58a calculates a step-specific working capability for each of the steps P1 to P5 in the second production line L2 and the third production line L3.

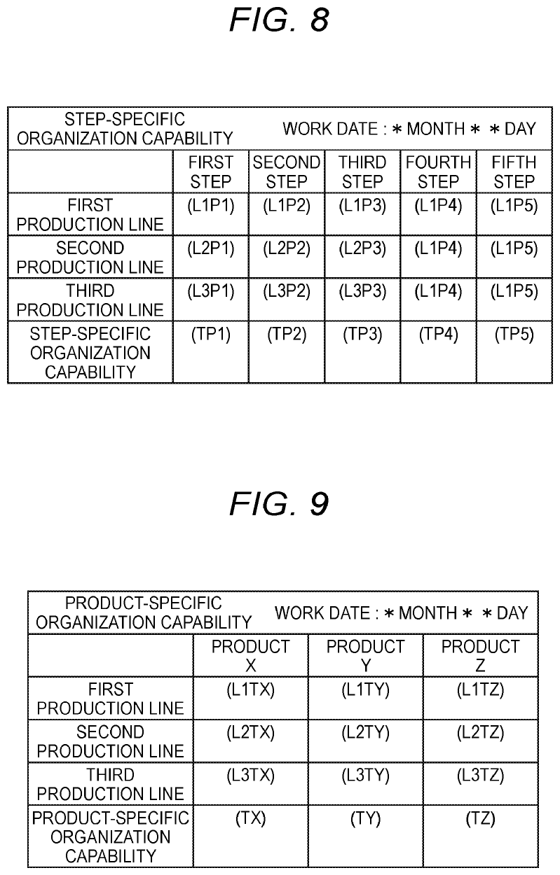

Next, as shown in FIG. 8, the step-specific organization capability calculation unit 58a calculates a step-specific organization capability, which is a step-specific working capability of the entire organization including all the production lines L1 to L3. For example, the step-specific organization capability calculation unit 58a calculates an average of the step-specific working capability L1P1 of the first step P1 of the first production line L1, a step-specific working capability L2P1 of the first step P1 of the second production line L2, and a step-specific working capability L3P1 of the first step P1 of the third production line L3 as a step-specific organization capability TP1 of the first step P1. Further, similarly to the case of the first step P1, the step-specific organization capability calculation unit 58a calculates step-specific organization capabilities TP2, TP3, TP4, and TP5 of the second step P2, the third step P3, the fourth step P4, and the fifth step P5.

In this way, the organization capability calculation unit 58 calculates an organization capability for each step. Thus, the organization manager can appropriately evaluate the step-specific working capabilities of the workers based on calculation results of the step-specific organization capability calculation unit 58a. That is, the manager can accurately grasp the step-specific organization capability by using the organization capability evaluation system 50. Therefore, when it is evaluated that an organization capability of a specific step is low, the manager can take measures to increase the organization capability of the step. Then, the manager can increase the productivity of the organization by increasing the step-specific organization capabilities of all the steps.

The step-specific organization capability calculation unit 58a can also calculate an average of the ranks XP1, YP1 and ZP1 of the first step P1 when manufacturing the products X, Y and Z in the first production line L1, the ranks XP1, YP1 and ZP1 of the first step P1 when manufacturing the products X, Y and Z in the second production line L2 and the ranks XP1, YP1 and ZP1 of the first step P1 when manufacturing the products X, Y, and Z in the third production line L3, as the step-specific organization capability of the first step P1.

Further, the step-specific organization capability calculation unit 58a can also calculate a variance of the ranks XP1, YP1 and ZP1 of the first step P1 when manufacturing the products X, Y and Z in the first production line L1, the ranks XP1, YP1 and ZP1 of the first step P1 when manufacturing the products X, Y and Z in the second production line L2 and the ranks XP1, YP1 and ZP1 of the first step P1 when manufacturing the products X, Y, and Z in the third production line L3, as the step-specific organization capability of the first step P1. In this case, the organization manager can grasp variation of the step-specific organization capabilities. Therefore, for example, when the variation of step-specific organization capabilities of all the steps P1 to P5 is large, the manager can take measures to reduce the variation.

Here, the step-specific organization capability calculation unit 58a calculates an average of the ranks using the number of workers belonging to the organization as the total number of samples, and sets a calculation result as a first step-specific organization capability. That is, the first step-specific organization capability is calculated as a step-specific organization capability in which the entire workers including a worker who does not have the organization capability of the step (having no working experience of the step) are used as samples. Thus, for example, when it is evaluated that a first step-specific organization capability in a specific step is low, the organization manager can determine that the number of workers having the working capability in the step is small or the number of workers having a high working capability in the step is small.

Further, the step-specific organization capability calculation unit 58a can also calculate a variance of the ranks as the first step-specific organization capability using the number of workers belonging to the organization as the total number of samples. In this case, when it is evaluated that a first step-specific organization capability in a specific step is low (that is, the variation is large), the organization manager can determine that the working capabilities of the workers in the step vary greatly or the number of workers having a high working capability in the step is small.

In addition, the step-specific organization capability calculation unit 58a calculates an average of the ranks as a second step-specific organization capability using the number of workers having the working capability among the workers belonging to the organization as the total number of samples. In this case, a value to be calculated by the step-specific organization capability calculation unit 58a is a step-specific organization capability in which only a worker having the organization capability of the step (having working experience of the step) is targeted. Therefore, for example, when it is evaluated that a second step-specific organization capability in a specific step is low, the organization manager can determine that the number of workers having a high working capability in the step is small.

Further, the step-specific organization capability calculation unit 58a can also calculate a variance of the ranks using the number of workers having the working capability among the workers belonging to the organization as the total number of samples, and output a calculation result as the second step-specific organization capability. In this case, when it is evaluated that a second step-specific organization capability in a specific step is low (that is, the variation is large), the organization manager can determine that the working capabilities of the workers in the step vary greatly. That is, an evaluation result that the second step-specific organization capability is low means that there is a high risk of lowering the organization capability when a worker having a high working capability is absent.

Further, in the example shown in FIG. 7, the product-specific organization capability calculation unit 58b calculates an average of the rank XP1 of the first step P1, the rank XP2 of the second step P2, the rank XP3 of the third step P3, the rank XP4 of the fourth step P4, and the rank XP5 of the fifth step P5 when manufacturing the product X, as a product-specific working capability L1 TX of the product X in the first production line L1. Similarly, the product-specific organization capability calculation unit 58b calculates an average of the rank YP1 of the first step P1, the rank YP2 of the second step P2, the rank YP3 of the third step P3, the rank YP4 of the fourth step P4, and the rank YP5 of the fifth step P5 when manufacturing the product Y, as a product-specific working capability L1 TY of the product Y in the first production line L1. Further, the product-specific organization capability calculation unit 58b calculates an average of the rank ZP1 of the first step P1, the rank ZP2 of the second step P2, the rank ZP3 of the third step P3, and the rank ZP5 of the fifth step P5 when manufacturing the product Z, as a product-specific working capability L1TZ of the product Z in the first production line L1.

Further, similarly to the case of the first production line L1, the product-specific organization capability calculation unit 58b calculates product-specific working capabilities of the product X, the product Y and the product Z in the second production line L2 and the third production line L3.

Next, as shown in FIG. 9, the product-specific organization capability calculation unit 58b calculates a product-specific organization capability which is a product-specific working capability of the entire organization including all the production lines L1 to L3. For example, the product-specific organization capability calculation unit 58b calculates an average of the product-specific working capability L1 TX of the product X of the first production line L1, the product-specific working capability L2TX of the product X of the second production line L2, and the product-specific working capability L3TX of the product X of the third production line L3, as a product-specific organization capability TX of the product X. Further, similarly to the case of the product X, the product-specific organization capability calculation unit 58b calculates product-specific organization capabilities TY and TZ of the product Y and the product Z.

In this way, the organization capability calculation unit 58 calculates the organization capability for each product. Accordingly, the organization manager can appropriately evaluate the product-specific working capabilities of the workers based on calculation results of the product-specific organization capability calculation unit 58b. That is, the manager can accurately grasp the product-specific organization capability by using the organization capability evaluation system 50. Accordingly, when it is evaluated that an organization capability when manufacturing a specific product is low, the manager can take measures to increase the organization capability when manufacturing the product. Further, the manager can increase the productivity of the organization by increasing product-specific organization capabilities of all the products to be manufactured.

The product-specific organization capability calculation unit 58b can also calculate an average of the ranks XP1 to XP5 of the respective steps P1 to P5 when manufacturing the product X in the first production line L1, the ranks XP1 to XP5 of the respective steps P1 to P5 when manufacturing the product X in the second production line L2, and the ranks XP1 to XP5 of the respective steps P1 to P5 when manufacturing the product X in the third production line L3, as the product-specific organization capability of the product X.

Further, the product-specific organization capability calculation unit 58b can also calculate a variance of the ranks XP1 to XP5 of the respective steps P1 to P5 when manufacturing the product X in the first production line L1, the ranks XP1 to XP5 of the respective steps P1 to P5 when manufacturing the product X in the second production line L2, and the ranks XP1 to XP5 of the respective steps P1 to P5 when manufacturing the product X in the third production line L3, as the product-specific organization capability of the product X. In this case, the organization manager can grasp variation of the product-specific organization capabilities. Therefore, for example, when the variation of the product-specific organization capabilities of all the products X, Y and Z is large, the manager can take measures to reduce the variation.

Here, the product-specific organization capability calculation unit 58b calculates an average of the ranks using the number of workers belonging to the organization as the total number of samples, and sets a calculation result as a first product-specific organization capability. That is, the first product-specific organization capability is a product-specific organization capability in which workers including a worker who does not have the organization capability of the product (having no working experience of the product) are used as samples. In this case, for example, when it is evaluated that a first product-specific organization capability of a specific product is low, the organization manager can determine that the number of workers having the working capability of the product is small or the number of workers having a high working capability of the product is small.

Further, the product-specific organization capability calculation unit 58b can also calculate a variance of the ranks as the first product-specific organization capability using the number of workers belonging to the organization as the total number of samples. In this case, when it is evaluated that a first product-specific organization capability of a specific product is low (that is, the variation is large), the organization manager can determine that the working capabilities of the workers of the product vary greatly or the number of workers having a high working capability of the product is small.

In addition, the product-specific organization capability calculation unit 58b calculates an average of the ranks as a second product-specific organization capability using the number of workers having the working capability among the workers belonging to the organization as the total number of samples. In this case, a value to be calculated by the product-specific organization capability calculation unit 58b is a product-specific organization capability in which only a worker having the organization capability of the product (having manufacturing experience of the product) is targeted. In this case, for example, when it is evaluated that a second product-specific organization capability of a specific product is low (that is, the variation is large), the organization manager can determine that the number of workers having a high working capability of the product is small.

Further, the product-specific organization capability calculation unit 58b can also calculate a variance of the ranks as the second product-specific organization capability using the number of workers having the working capability among the workers belonging to the organization as the total number of samples. In this case, when it is evaluated that a second product-specific organization capability of a specific product is low (that is, the variation is large), the organization manager can determine that the working capabilities of the workers of the product vary greatly.

The line-specific organization capability calculation unit 58c calculates an organization capability for each production line based on the step-specific organization capability of each of the production lines L1 to L3 calculated by the step-specific organization capability calculation unit 58a, or the product-specific organization capability of each of the production lines L1 to L3 calculated by the product-specific organization capability calculation unit 58b.

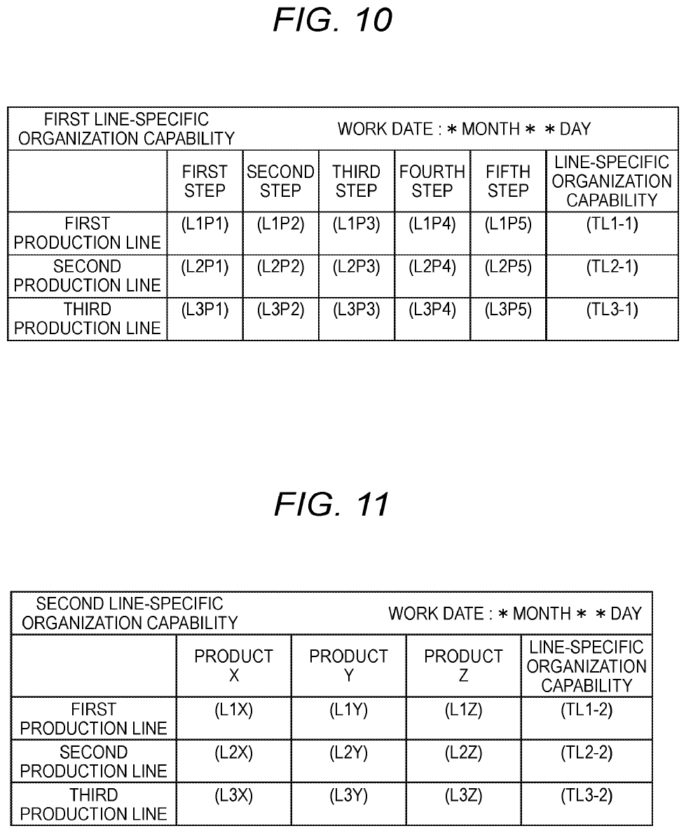

As shown in FIG. 10, for example, the line-specific organization capability calculation unit 58c calculates an average of the step-specific organization capabilities TP1 to TP5 of the respective steps P1 to P5 of the first production line L1 as a first line-specific organization capability TL1-1 of the first production line L1. Further, similarly to the case of the first production line L1, the line-specific organization capability calculation unit 58c calculates line-specific organization capabilities TL2-1 and TL3-1 of the second production line L2 and the third production line L3.

Further, as shown in FIG. 11, for example, the line-specific organization capability calculation unit 58c calculates an average of the product-specific organization capabilities TX to TZ of the respective products X to Z of the first production line L1 as a second line-specific organization capability TL1-2 of the first production line L1. Further, similarly to the case of the first production line L1, the line-specific organization capability calculation unit 58c calculates second line-specific organization capabilities TL2-2 and TL3-2 of the second production line L2 and the third production line L3.

In this way, the organization capability calculation unit 58 calculates the organization capability for each of the production lines L1 to L3. Accordingly, the organization manager can appropriately evaluate the organization capability for each of the production lines L1 to L3 based on the calculation results of the line-specific organization capability calculation unit 58c. That is, the manager can accurately grasp the organization capability of each of the production lines L1 to L3 by using the organization capability evaluation system 50. Therefore, when it is evaluated that an organization capability of a specific production line is lower than organization capabilities of the other production lines, the manager can take measures to increase the organization capability of the specific production line. Then, the manager can increase the productivity of the organization by increasing the organization capability of each production line in all the production lines L1 to L3.

For example, when a line-specific organization capability of a specific production line on a specific working day is lower than line-specific organization capabilities of the production line on other working days, the manager can confirm an arrangement of workers on the production line on the specific working day based on recorded contents of the work record storage unit 53. Then, the manager can easily specify a step considered to be a bottleneck by grasping a step-specific working capability of the production line on the working day. Further, when an individual capability of a worker in charge of the bottleneck step is low, the manager can estimate that the low individual capability of the worker is a cause of lowering the line-specific organization capability.

Further, in the organization capability evaluation system 50, the working capability calculation unit 55 calculates the achievement degree and stability degree of the working times, and the organization capability calculation unit 58 calculates the organization capability based on the calculated achievement degree and stability degree of the working times. Therefore, the organization manager can appropriately evaluate the organization capability. That is, the manager can grasp the achievement degree and stability degree of the working times with respect to the reference working time by using the organization capability evaluation system 50. Therefore, when it is evaluated that the organization capability is low, the manager can take measures to increase the organization capability. Then, the manager can stabilize the productivity of the organization at a high level by increasing the organization capability.

Next, the individual capability calculation unit 61 and the individual capability storage unit 62 (with reference to FIG. 2B) will be described. The individual capability calculation unit 61 calculates, based on the recorded contents in the work record storage unit 53 and the step-specific working capabilities, a step-specific working capability of a worker belonging to the organization as an individual capability of each worker.

The individual capability calculation unit 61 specifies a worker who operates a specific machine tool M (who is in charge of a specific step) on a specific working day based on the work performances recorded in the work record storage unit 53. In other words, the individual capability calculation unit 61 specifies a production line to which a specific worker is allocated, and a step in the production line which the specific worker is in charge of on a specific working day, based on the work performances.

Subsequently, the individual capability calculation unit 61 associates the worker with a step-specific working capability stored in the working capability storage unit 57. That is, the individual capability calculation unit 61 associates a step which the worker is in charge of with a step-specific working capability in the step, and thereby identifying the step-specific working capability in the step as the individual capability of the worker. An individual capability history of each worker calculated by the individual capability calculation unit 61 is stored in the individual capability storage unit 62.

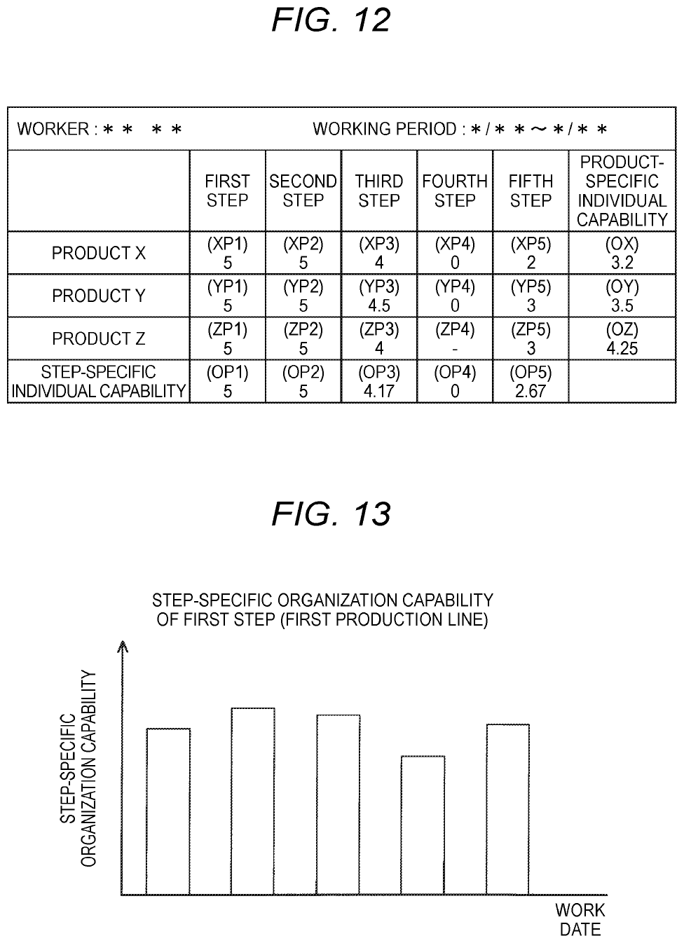

Further, as shown in FIG. 12, the individual capability calculation unit 61 calculates individual capability data of each worker periodically (for example, every week) by using the individual capability history of each worker stored in the individual capability storage unit 62. For example, the individual capability calculation unit 61 extracts an individual capability history within a predetermined period (for example, three months) for each worker. Then, the individual capability calculation unit 61 calculates, for each product, an average of the step-specific individual capabilities using the extracted individual capability history, and sets a calculation result as the individual capability data.

Then, the organization manager can grasp the individual capabilities of the workers in a predetermined period by confirming the individual capability data. That is, the manager can determine allocation of the workers to the respective production lines L1 to L3 and responsibility of the workers in the respective production lines L1 to L3 with reference to the individual capability data. As a result, the manager can smoothly determine an arrangement of the workers in the respective production lines L1 to L3. Further, since the manager can appropriately arrange the workers, the productivity of the organization can be improved.

Regarding the predetermined period, when the organization manger sets the predetermined period including the current time to be short, the individual capability calculation unit 61 can generate individual capability data according to a current individual capability. Meanwhile, when the manager set the predetermined period to be long, more individual capability data can be generated.

That is, the individual capability of the worker is considered to be improved by accumulating the work performances. Therefore, an old work performance does not necessarily reflect a current individual capability, and when the predetermined period is set to be long, the calculated individual capability tends to be evaluated lower than an original individual capability. On the other hand, when the predetermined period is shortened, steps which the worker is in charge of within the predetermined period are also reduced. That is, regarding a step which a worker is not in charge of within the predetermined period, even if a working capability of the worker in the step is high, it is evaluated that the worker does not have the working capability of the step in a calculation process of the individual capability calculation unit 61. Considering these points, the manager can accurately grasp the individual capability by appropriately setting a predetermined period based on the individual capability history stored in the individual capability storage unit 62.

Further, the individual capability calculation unit 61 can also calculate step-specific comprehensive individual capability data and product-specific comprehensive individual capability data for each worker based on the individual capability data. That is, the individual capability calculation unit 61 can calculate an average of the rank XP1 of the individual capability of the first step P1 in the product X, the rank YP1 of the individual capability of the first step P1 in the product Y, and the rank ZP1 of the individual capability of the first step P1 in the product Z, and set a calculation result as step-specific comprehensive individual capability data OP1 of the first step P1. Further, similarly to the case of the step-specific comprehensive individual capability data OP1 of the first step P1, the individual capability calculation unit 61 can calculate step-specific comprehensive individual capability data OP2 to OP5 of the second step P2, the third step P3, the fourth step P4, and the fifth step P5.

Further, the individual capability calculation unit 61 can calculate an average of the rank XP1 of the individual capability of the first step P1 in the product X, the rank XP2 of the individual capability of the second step P2 in the product X, the rank XP3 of the individual capability of the third step P3 in the product X, the rank XP4 of the individual capability of the fourth step P4 in the product X, and the rank XP5 of the individual capability of the fifth step P5 in the product X, and set a calculation result as product-specific comprehensive individual capability data OX of the product X. Further, similarly to the case of the product-specific comprehensive individual capability data OX of the product X, the individual capability calculation unit 61 can calculate product-specific comprehensive individual capability data OY and OZ of the product Y and the product Z.

In addition, as described above, the organization capability evaluation system 50 includes the skilled worker extraction unit 63, the required skilled workers number storage unit 64, and the sufficiency rate calculation unit 65. The skilled worker extraction unit 63 extracts, for each step and each product, a worker (hereinafter, referred to as “skilled worker”) having individual capability being equal to or higher than a predetermined level based on the individual capabilities of the respective workers stored in the individual capability storage unit 62.

For example, in a case where working capability ranking performed by the ranking unit 56 includes five levels, the skilled worker extraction unit 63 extracts a worker whose individual capability rank in the first step P1 of the product X is 4 or more among the workers belonging to the organization. Similarly, the skilled worker extraction unit 63 extracts a worker whose individual capability rank is 4 or more for each step and each product. Based on a setting of the organization manager or the like, the skilled worker extraction unit 63 may extract a worker whose individual capability rank is 3 or more, and may extract only a worker whose rank is 5.

The required skilled workers number storage unit 64 stores the number of skilled workers required in each of the steps P1 to P5 as the required number of skilled workers for each step. The organization manager or the like determines the required number of skilled workers of each step for each product, and stores the number in the required skilled workers number storage unit 64.

In this regard, if there is only one skilled worker in a specific step of a specific product, the step-specific organization capability of the step and the product-specific organization capability of the product may be reduced if the skilled worker is absent for some reason. Therefore, the manager or the like can prevent an organization capability decrease and organization capability variation associated with absence of a part of the skilled workers by securing a certain number of skilled workers in each of the steps P1 to P5 when manufacturing each of the products X, Y and Z.

The sufficiency rate calculation unit 65 calculates, based on the number of skilled workers extracted by the skilled worker extraction unit 63 and the required number of skilled workers stored in the required skilled workers number storage unit 64, a skilled worker sufficiency rate indicating a ratio of the number of skilled workers to the required number of skilled workers. For example, in a case where the required number of skilled workers is 2 in a specific step of a specific product, if the number of extracted skilled workers is 2, the sufficiency rate calculation unit 65 sets a skilled worker sufficiency rate to 100%. In this case, if the number of extracted skilled workers is 1, the skilled worker sufficiency rate is 50%, and if the number of extracted skilled workers is 3, the skilled worker sufficiency rate is 150%.

As a result, the organization manager can grasp a step with a low skilled worker sufficiency rate for each product. For example, in a case where there is a step with a low skilled worker sufficiency rate, the manager can increase the number of skilled workers in the step by training a worker who is not a skilled worker among workers having the individual capability of the step. Further, in the case where there is a step with a low skilled worker sufficiency rate, the manager can increase the number of skilled workers in the step by allocating a worker who does not have the individual capability of the step (having no working experience of the step) to the step and training the worker.

In this case, in a production plan of the organization, the manager can allocate a skilled worker of a specific step to train a worker who is in charge of the step and who is not a skilled worker, on a working day when the manufacturing number of products that the organization can manufacture is more than the manufacturing number of products that is required. Thus, the organization manager can train a worker whose working capability does not reach a predetermined level or more while ensuring the productivity of the organization.

As described above, the organization capability evaluation system 50 includes the display unit 70 that displays calculation results of the organization capability calculation unit 58, the individual capability calculation unit 61, and the sufficiency rate calculation unit 65. For example, the display unit 70 displays the calculation results of the step-specific working capabilities calculated by the step-specific organization capability calculation unit 58a on a display device such as a fixed terminal or a mobile terminal that can be used by the organization manager or the like. The display unit 70 can display, on a display device, data indicating transition of the organization capabilities calculated by the organization capability calculation unit 58.

FIG. 13 shows, as an example of data indicating transition of the organization capabilities displayed by the display unit 70, a graph showing transition of step-specific organization capabilities of the first step P1 calculated by the step-specific organization capability calculation unit 58a. The organization manager can easily grasp transition of the step-specific organization capabilities by confirming the transition of the step-specific organization capabilities as shown in FIG. 13. Similarly to a case of the above data indicating the transition of step-specific organization capabilities, the display unit 70 can display data indicating transition of the product-specific organization capabilities of each of the products X to Z calculated by the product-specific organization capability calculation unit 58b and data indicating transition of line-specific organization capabilities of each of the production lines L1 to L3 calculated by the line-specific organization capability calculation unit 58c.

In this way, the display unit 70 can display transition of step-specific organization capabilities of each of the steps P1 to P5 calculated by the step-specific organization capability calculation unit 58a. That is, the manager can grasp, at a glance, a working day with a reduced organization capability and variation of organization capabilities of respective working days.

Further, the display unit 70 can also display, on the display device, data indicating transition of the working capabilities stored in the working capability storage unit 57. In this case, for example, the manager can find out, in a step in which a specific machine tool M is used, a possibility that some trouble has occurred in the machine tool M when the step-specific working capability is not improved despite the change of the worker in charge of the step.

Further, the display unit 70 can display the skilled worker sufficiency rate calculated by the sufficiency rate calculation unit 65. Therefore, in a case where the working capability in a specific step is low, the manager can find the necessity of training to obtain a skilled worker in the step when the skilled worker sufficiency rate in the step is low.

As described above, the organization capability evaluation system 50 calculates the step-specific working capability, and calculates the organization capability for each step, each product, or each production line based on the calculated step-specific working capability. Therefore, the organization capability evaluation system 50 can appropriately evaluate the organization capability. Further, the organization manager can grasp objective evaluation of the organization capability by acquiring the calculation result of the organization capability by the organization capability evaluation system 50. Then, the manager can increase the productivity of the organization by taking measures according to the evaluation of the acquired organization capability.

In addition, it is desirable that the organization capability evaluation system 50 can calculate at least two of the step-specific organization capability, the product-specific organization capability, and the line-specific organization capability. In this case, since the organization manager can grasp the organization capability multilaterally, the organization capability can be grasped more accurately.

### REFERENCE SIGNS LIST

50: organization capability evaluation system
51: work performance acquisition unit
52: inspection result acquisition unit
53: work record storage unit
54: evaluation reference storage unit
55: working capability calculation unit
55a: achievement degree calculation unit
55b: stability degree calculation unit
56: ranking unit
57: working capability storage unit
58: organization capability calculation unit
58a: step-specific organization capability calculation unit
58b: product-specific organization capability calculation unit
58c: line-specific organization capability calculation unit
61: individual capability calculation unit
62: individual capability storage unit
63: skilled worker extraction unit
64: required skilled workers number storage unit
65: sufficiency rate calculation unit
70: display unit
L1: first production line (production line)
L2: second production line (production line)
L3: third production line (production line)

What is claimed is:

1. An organization capability evaluation system configured to evaluate an organization capability when an organization including a plurality of workers manufactures various products through a plurality of steps, comprising:
a work performance acquisition unit configured to acquire a working time required for work in each of the plurality of steps as a step-specific work performance;
an evaluation reference storage unit configured to store a reference working time set for each of the steps as an evaluation reference when evaluating the step-specific work performance;
a working capability calculation unit configured to calculate a working capability of each step based on the step-specific work performance and the reference working time;
a working capability storage unit configured to store the working capability of each step calculated by the working capability calculation unit as a step-specific working capability; and
a step-specific organization capability calculation unit configured to calculate the organization capability for each step based on the step-specific working capability.

2. The organization capability evaluation system according to claim 1, wherein
the organization capability calculation unit is a step-specific organization capability calculation unit configured to calculate the organization capability for each step based on the step-specific working capability, a product-specific organization capability calculation unit configured to calculate the organization capability for each product based on the step-specific working capability, or a line-specific organization capability calculation unit configured to calculate the organization capability for each production line based on the step-specific working capability.

3. The organization capability evaluation system according to claim 1, wherein
the working capability calculation unit includes:
an achievement degree calculation unit configured to calculate an achievement degree of the working times with respect to the reference working time based on the plurality of step-specific work performances and the reference working time; and
a stability degree calculation unit configured to calculate a stability degree of the working times with respect to the reference working time based on the plurality of work performances and the reference working time, and wherein
the stability degree is a variance of working times.

4. The organization capability evaluation system according to claim 2 further comprising:
a ranking unit configured to perform ranking step-specific working capability according to the step-specific working capabilities calculated by the working capability calculation unit, wherein
the step-specific organization capability calculation unit, the product-specific organization capability calculation unit, or the line-specific organization capability calculation unit are configured to calculate the step-specific organization capability, the product-specific organization capability or the line-specific organization capability based on ranks of the step-specific working capabilities ranked by the ranking unit.

5. The organization capability evaluation system according to claim 4, wherein
the step-specific organization capability calculation unit, the product-specific organization capability calculation unit, or the line-specific organization capability calculation unit are configured to calculate at least one of an average and variance of the ranks as the step-specific organization capability, the product-specific organization capability, or the line-specific organization capability.

6. The organization capability evaluation system according to claim 5, wherein
the step-specific organization capability calculation unit, the product-specific organization capability calculation unit or the line-specific organization capability calculation unit are configured to calculate the average or variance of the ranks using a number of workers belonging to the organization as the total number of samples.

7. The organization capability evaluation system according to claim 5, wherein
the step-specific organization capability calculation unit, the product-specific organization capability calculation unit or the line-specific organization capability calculation unit are configured to calculate the average or variance of the ranks using the number of workers having the working capability of the workers belonging to the organization as the total number of samples.

8. The organization capability evaluation system according to claim 1 further comprising:
an individual capability calculation unit configured to calculate the step-specific working capability of each of the workers belonging to the organization as a worker-specific individual capability based on the work performance and the step-specific working capability.

9. The organization capability evaluation system according to claim 8 further comprising:
a skilled worker extraction unit configured to extract a worker having individual capability being equal to or higher than a predetermined level as a skilled worker;
a required skilled workers number storage unit configured to store the number of skilled workers required in each step as the required number of skilled workers of each step; and
a sufficiency rate calculation unit configured to calculate a skilled worker sufficiency rate with respect to the required number of skilled workers based on the number of skilled workers extracted by the skilled worker extraction unit and the required number of skilled workers.

10. The organization capability evaluation system according to claim 2 further comprising:
an inspection result acquisition unit configured to acquire an inspection result of quality inspection performed on the product manufactured by the organization, wherein
the step-specific organization capability calculation unit, the product-specific organization capability calculation unit, or the line-specific organization capability calculation unit are configured to calculate an achievement degree or stability degree of the inspection results for each step, each product, or each production line.

11. The organization capability evaluation system according to claim 2 further comprising:
a display unit configured to display the step-specific organization capability calculated by the step-specific organization capability calculation unit, the product-specific organization capability calculated by the product-specific organization capability calculation unit, or the line-specific organization capability calculated by the line-specific organization capability calculation unit, wherein
the display unit is configured to display transition of the step-specific organization capability, the product-specific organization capability, or the line-specific organization capability.

12. An organization capability evaluation system configured to evaluate an organization capability when an organization including a plurality of workers manufactures various products through a plurality of steps, comprising:
a work performance acquisition unit configured to acquire a working time required for work in each of the plurality of steps as a step-specific work performance;
an evaluation reference storage unit configured to store a reference working time set for each of the steps as an evaluation reference when evaluating the work performance;
a working capability calculation unit configured to calculate a working capability of each step based on the step-specific work performance and the reference working time;
an achievement degree calculation unit configured to calculate an achievement degree of the working times with respect to the reference working time for each of the steps based on the plurality of step-specific work performances and the reference working time;
a stability degree calculation unit configured to calculate a stability degree of the working times with respect to the reference working time for each of the steps based on the plurality of step-specific work performances and the reference working time; and
an organization capability calculation unit configured to calculate the organization capability based on the achievement degree and the stability degree, and wherein the stability degree is a variance of working times.
